(19) United States
(12) Patent Application Publication
(10) Pub. No.: US 2022/0142852 A1
(43) Pub. Date: May 12, 2022

(54) MASSAGE COMB

(71) Applicant: PUSHI Accessory Co., LTD., Yiwu (CN)

(72) Inventor: Peng-Fei CHU, Yiwu (CN)

(21) Appl. No.: 17/327,398

(22) Filed: May 21, 2021

(30) Foreign Application Priority Data
Nov. 10, 2020 (CN) 202022585511.8

(51) Int. Cl. A61H 11/00; A61H 15/00; A61H 39/04; A45D 24/18

(52) U.S. Cl. CPC A61H 11/00; A61H 15/0092; A61H 39/04; A61H 2201/0107; A61H 2015/0064; A61H 2201/1253; A45D 24/18

(57) ABSTRACT

A massage comb includes a comb body, a handle, a plurality of teeth, and a rolling bead. The handle is disposed below the comb body and integrated with the comb body, the plurality of teeth are arranged on the comb body at intervals, and the rolling bead is rollably disposed at the end of the handle. Since the massage comb is provided with rolling bead at the end of the handle, before or after combing the hair, the rolling bead can be used to massage the acupuncture points in the head, which facilitates opening the head meridian and enhancing blood circulation in the head. In addition, the rolling bead is arranged at the end of the handle, so that the massage comb of the present invention has a dual-purpose effect.

### RELATED APPLICATIONS

This application claims the benefit of priority to Chinese Utility Model Application No. 202022585511.8 filed on Nov. 10, 2020, which is hereby incorporated by reference in its entirety.

### FIELD OF THE INVENTION

The present invention relates to a personal accessory for use in head care, more particularly to a massage comb.

### BACKGROUND OF THE INVENTION

With the development of technology and humanities, people pay more attention to head care. In recent years, head care products have gradually been favored by people.

Head care refers to scalp care, hair care and head acupuncture massage. A hair comb is one of the common hairdressing tools, which can comb the hair down. In recent years, as people pay more attention to the head, combs are gradually provided with various health functions, such as a massage function. Some rolling balls on are disposed on the top of the teeth. When the comb is used to gently tap the head, slight vibration of the balls can relax the scalp well.

However, currently, there is no hair comb that can massage acupuncture points on the head.

Therefore, there is an urgent need for a massage comb that can massage acupuncture points on the head to overcome the above-mentioned shortcomings.

### SUMMARY OF THE INVENTION

One objective of the present invention is to provide a massage comb that can massage acupuncture points on the head.

To achieve the above objective, a massage comb is provided, which includes a comb body, a handle, a plurality of teeth, and a rolling bead. The handle is disposed below the comb body and integrated with the comb body, the plurality of teeth are arranged on the comb body at intervals, and the rolling bead is rollably disposed at the end of the handle.

Preferably, the rolling bead is capable of rotating 360 degree at the end of the handle.

Preferably, the rolling bead is detachably arranged at the end of the handle.

Preferably, the massage comb further includes a mounting sleeve detachably connected to the end of the handle, and the rolling bead is rollably provided in the mounting sleeve.

Preferably, the rolling bead is partially disposed in the mounting sleeve and partially exposed outside the mounting sleeve.

Preferably, the mounting sleeve is provided with a mounting cavity for the rolling bead to roll 360 degree.

Preferably, the mounting cavity has a spherical structure between a hemispherical shape and a full spherical shape.

Preferably, the mounting sleeve is engaged with or threadably coupled to the end of the handle.

Preferably, the rolling bead is completely or partially exposed outside the handle.

Preferably, the rolling bead is pivotally connected to the handle through a pivot.

In comparison with the prior art. since the massage comb is provided with rolling bead at the end of the handle, before or after combing the hair, the rolling bead can be used to massage the acupuncture points in the head, which facilitates opening the head meridian and enhancing blood circulation in the head. In addition, the rolling bead is arranged at the end of the handle, so that the massage comb of the present invention has a dual-purpose effect.

### BRIEF DESCRIPTION OF THE DRAWINGS

The accompanying drawings facilitate an understanding of the various embodiments of this invention. In such drawings:

FIG. 1 is a perspective view of a massage comb according to an embodiment of the present invention;

FIG. 2 is a front view of the massage comb; and

FIG. 3 is an exploded view of the massage comb.

### DETAILED DESCRIPTION OF ILLUSTRATED EMBODIMENTS

A distinct and full description of the technical solution of the present invention will follow by combining with the accompanying drawings.

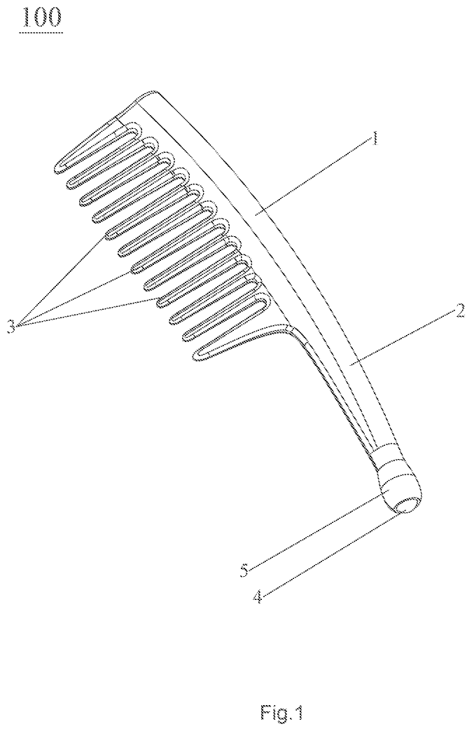

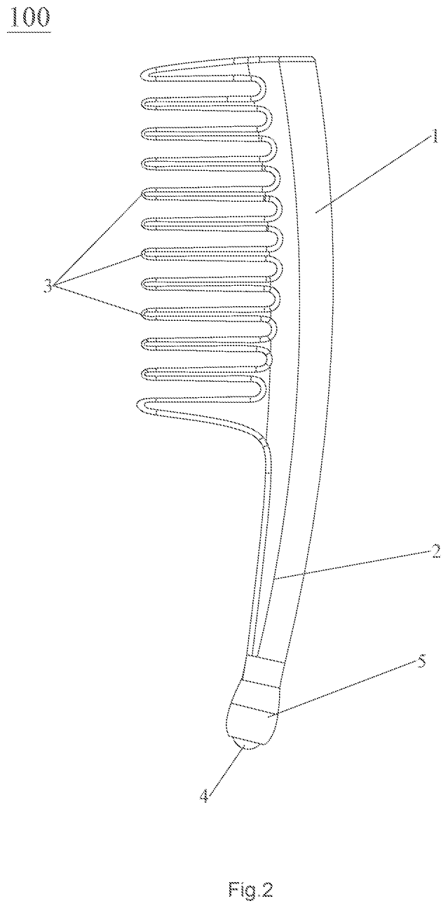

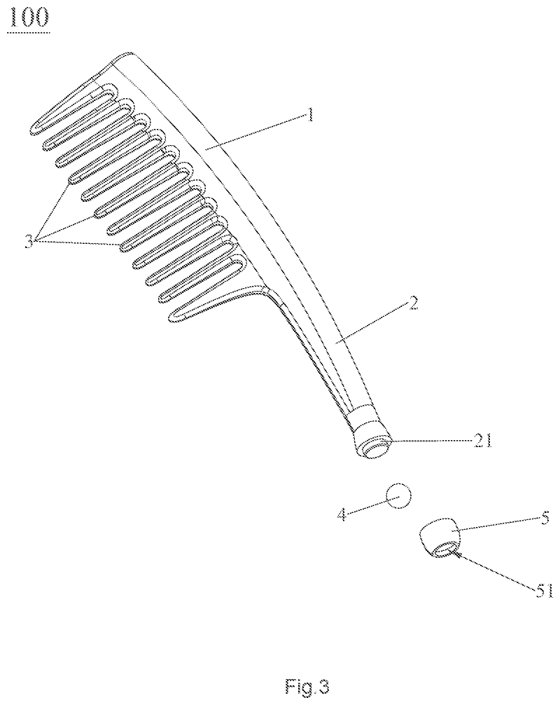

As shown in FIGS. 1-3, the massage comb 100 according to an embodiment of the present invention includes a comb body 1, a handle 2, a plurality of teeth 3, and a rolling bead 4. The handle 2 is disposed below the comb body 1 and integrated with the comb body 1. The plurality of teeth 3 are arranged on the comb body 1 at intervals, and the rolling bead 4 is rollably disposed at the end of the handle 2. Thus, before or after combing the hair, the rolling bead 4 rollably provided at the end of the handle 2 can be used to massage the acupuncture points in the head, thereby facilitating opening the head meridian and enhancing blood circulation in the head. In addition, the rolling bead 4 is arranged at the end of the handle 2, so that the massage comb 100 has dual-purpose effect. Preferably, in this embodiment, the rolling bead 4 is capable of rotating 360 degree at the end of the handle 2 without restricting the rotation direction of the rolling bead 4, thereby making manual operation more convenient.

Referring to FIGS. 1 to 3, the rolling bead 4 is detachably arranged at the end of the handle 2. Specifically, the massage comb 100 further includes a mounting sleeve 5 detachably connected to the end of the handle 2, and the rolling bead 4 is rollably provided in the mounting sleeve 5, thereby connecting detachably the rolling bead 4, so that a user disassembles and assembles the rolling bead 4 easily, so it is easy to replace parts and simplify the production process. Preferably, the rolling bead 4 is partially disposed in the mounting sleeve 5, namely the rolling bead 4 is partially exposed outside the mounting sleeve 5, so that the part of the rolling bead 4 exposed contacts the user's head. The mounting sleeve 5 is provided with a mounting cavity 51 for the rolling bead 4 to roll 360 degree. The mounting cavity 51 has a spherical structure between a hemispherical shape and a full spherical shape, thereby ensuring that the tolling bead 4 can roll and preventing the rolling bead 4 from escaping from the mounting sleeve 5.

Referring to FIGS. 1 to 3 again, the mounting sleeve 5 is engaged with the end of the handle 2. Of course, in other embodiments, the mounting sleeve 5 is threadably coupled to the end of the handle 2, but it is not limited to this. Specifically, the end of the handle 2 is also protruded to form a protruding portion 21 which is used to abut the rolling bead 4, so that the rolling bead 4 is partially exposed outside the mounting sleeve 5 when it is mounted.

Of course, in other embodiments (not shown in the drawings), the rolling bead is completely or partially exposed outside the handle. For example, the rolling bead is pivotally connected to the handle through a pivot. Specifically, the pivot is inserted into the rolling bead and the end of the handle at the same time. At this time, the rolling bead cannot roll in all directions and can only rotate around the pivot.

In comparison with the prior art, the massage comb 100 is provided with rolling bead 4 at the end of the handle 2. Before or after combing the hair, the rolling bead 4 can be used to massage the acupuncture points in the head, which facilitates opening the head meridian and enhancing blood circulation in the head. In addition, the rolling bead 4 is arranged at the end of the handle 2, so that the massage comb 100 of the present invention has a dual-purpose effect.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A massage comb, comprising a comb body, a handle, and a plurality of teeth, the handle being disposed below the comb body and integrated with the comb body, the plurality of teeth being arranged on the comb body at intervals, wherein the massage comb further comprises a rolling bead rollably disposed at the end of the handle.

2. The massage comb according to claim 1, wherein the roiling bead is capable of rotating 360 degree at the end of the handle.

3. The massage comb according to claim 1, wherein the rolling bead is detachably arranged at the end of the handle.

4. The massage comb according to claim 3, wherein the massage comb further comprises a mounting sleeve detachably connected to the end of the handle, and the rolling bead is rollably provided in the mounting sleeve.

5. The massage comb according to claim 4, wherein the rolling bead is partially disposed in the mounting sleeve and partially exposed outside the mounting sleeve.

6. T he massage comb according to claim 5, wherein the mounting sleeve is provided with a mounting cavity for the rolling bead to roll 360 degree.

7. The massage comb according to claim 6, wherein the mounting cavity has a spherical structure between a hemispherical shape and a full spherical shape.

8. The massage comb according to claim 4, wherein the mounting sleeve is engaged with or threadably coupled to the end of the handle.

9. The massage comb according to claim 1, wherein the rolling bead is completely or partially exposed outside the handle.

10. The massage comb according to claim 9, wherein the rolling bead is pivotally connected to the handle through a pivot.
